(19) United States
(12) Patent Application Publication
(10) Pub. No.: US 2002/0026298 A1
(43) Pub. Date: Feb. 28, 2002

(54) METHOD FOR ANALYZING A FABRICATION MACHINE CLUSTER USING-GENETIC ALGORITHMS

(76) Inventors: MENG-LIN YEH, TAIPEI (TW); JASMINE WU, CHANGHUA (TW)

Correspondence Address: J.C. PATENTS INC., 4 VENTURE, SUITE 250, IRVINE, CA, 92618, US

(21) Appl. No.: 09/200,330

(22) Filed: Nov. 25, 1998

(30) Foreign Application Priority Data
Sep. 19, 1998 (TW) 87115637

(51) Int. Cl. G06F 17/10

(52) U.S. Cl. 703/2

(57) ABSTRACT

An analysis method for analyzing a consequent effect of a fabrication machine cluster is provided. The method uses an AND logic algorithm to compare a fabrication machine cluster having a low yield rate with a fabrication machine cluster having a high yield rate. Each fabrication machine cluster includes a series of machines. Each of machine is used in a fabrication process. If an element machine used in a process for the fabrication machine cluster having a low yield rate is different from an element machine used in the same process for the fabrication machine cluster having a high yield rate, a logic result is indicated as “0”. Otherwise, the logic result is indicated as “1”. A modification of the fabrication cluster may be done by replacing the machine indicated by “0” with other available machine.

### CROSS-REFERENCE TO RELATED APPLICATION

This application claims the priority benefit of Taiwan application serial no. 87115637, filed Sep. 19, 1998, the full disclosure of which is incorporated herein by reference.

### BACKGROUND OF THE INVENTION

1. Field of the Invention

This invention relates to semiconductor fabrication, and more particularly to a method using a logic algorithm for analyzing a consequent effect of a fabrication machine cluster.

2. Description of Related Art

In semiconductor fabrication, one batch, which includes several wafers, needs to pass several fabrication machines in different fabrication processes, such as deposition, etching, or sputtering machines. Each fabrication machine has its own performance and its own series number. In order to have massive production, a same fabrication process may use same-type fabrication machines provided by different manufacturers. Since semiconductor fabrication needs very high precision and highly reduced dimension, discrepancy of fabrication performance between each of the same-type different machines is strictly required to be consistent in a certain small range. In addition, for one fabrication machine, its fabrication performance may also drift away after a period of operation time. All above fabrication variances may cause a fabrication failure due to a consequent effect, which is an accumulated effect of the fabrication variances in each machine used for each fabrication process. The yield rate is therefore reduced. A poor yield rate may particularly occurs at a certain fabrication machine cluster, which includes several machines sequentially used in each step of fabrication processes. Each machine has its own series number to be recorded for the fabrication machine cluster.

If manufacturers want to analyze the reason that causes the poor yield rate on that certain fabrication machine cluster, conventionally, it is done by manufacturers using their experiences. If the fabrication machine cluster includes a complicate situation or a large amount of data, out of handle by the manufacturers, to be analyzed, some important key reasons may often be ignored, resulting in a wrong judgement.

Moreover, a conventional method for analyzing discrepancies between different machines used in a same fabrication process is not suitable for an analysis of the consequent effect in a fabrication machine cluster. The actual reasons causing the poor yield rate still cannot be analyzed out.

In order to increase a total yield rate, an analysis method to effectively analyze the consequent effect is therefore strongly desired to more precisely judge the reasons causing the poor yield rate in certain fabrication machine clusters.

### SUMMARY OF THE INVENTION

It is therefore an objective of the present invention to provide an analysis method for analyzing a consequent effect of a fabrication cluster. The analysis method can handle a large amount of data for a complicate fabrication cluster so that an actual reason causing a poor yield rate in a certain fabrication machine cluster can be precisely determined. A modification of on the fabrication machine cluster having low yield rate can be precisely done to increase its yield rate.

In accordance with the foregoing and other objectives of the present invention, an analysis method for analyzing a consequent effect of a fabrication cluster is provided. The analysis method includes providing a data base of high-yield DNA codes. A DNA code represents a sequential machine number of a fabrication machine cluster. The data base of the high-yield DNA codes include several DNA codes, all of which have high yield rate. A low-yield DNA code is also provided to be analyzed. An “AND” logic operation preferably is performed to compare the low-yield DNA code with one of the high-yield DNA codes from the data base. Each DNA element code in the DNA codes represents one used fabrication machine in a specified fabrication process. If a DNA element code of the low-yield DNA code is consistent with a DNA element code of the high-yield DNA code, a resulting element code is indicate by “1” for this specified fabrication machine. If they are different, this resulting element code is indicated by “0”. After the low-yield DNA code is completely compared, for example, at least one of the resulting element code is indicated by “0”. A modification process is performed to replace the resulting element having “0” with one of other same-type machines in its specified fabrication process.

In the foregoing, the analysis method of the invention for analyzing the consequent effect is using a logic algorithm to determine fabrication machines, which may cause the poor yield rate. The analysis method can analyze a large amount of data with a complicate fabrication machine cluster without missing any possible factor causing the poor yield rate.

### BRIEF DESCRIPTION OF DRAWINGS

The invention can be more fully understood by reading the following detailed description of the preferred embodiment, with reference made to the accompanying drawings as follows:

FIG. 1 is a flow diagram of fabrication processes for one batch passing several fabrication machines; and

FIG. 2 is an AND logic operation algorithm of an analysis method for a consequent effect, according to a preferred embodiment of the invention.

### DETAILED DESCRIPTION OF PREFERRED EMBODIMENT

In fabrication processes, each batch has it own log including a history of the batch performed in a certain fabrication machine at a certain step. Each machine is indicated by, for example, an element number or an element code. All the sequentially used fabrication machines form a fabrication machine cluster. The fabrication machine cluster contains those element codes, which form a DNA code like a biologic DNA structure. One DNA code represents one fabrication machine cluster or one history of the batch passing fabrication machines in the whole fabrication process. Each different batch has its own DNA code serving as a log of the fabrication history. The yield rate of the each batch depends on its DNA code.

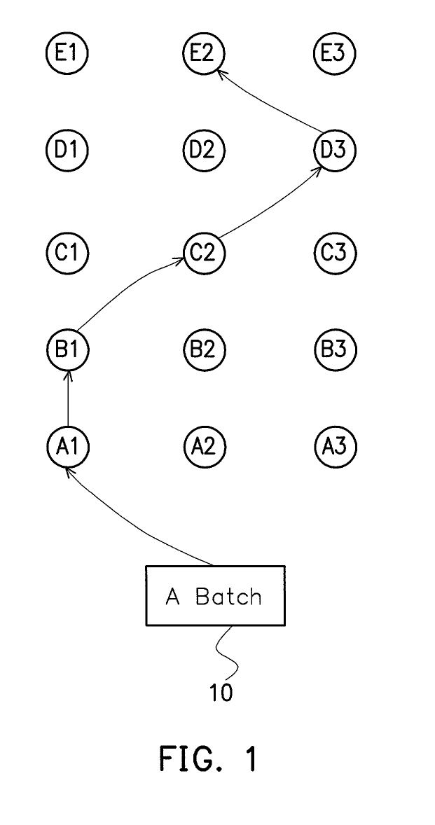

For example, FIG. 1 is a flow diagram of fabrication processes for one batch passing several fabrication machines. In FIG. 1, each circle represents one element code of the fabrication machines. A batch 10 needs to pass five fabrication processes, A, B, C, D, and E. There are three same-type fabrication machines, indicated by 1, 2, and 3, available for each process. Each of these three same-type fabrication machines may also be provided by different machine manufacturers. The batch 10 may be fabricated by, for example, passing a sequence of fabrication process, which is, for example, represented by a DNA code of A1-B1-C2-D3-E2. Each of A1, B1, C2, D3, and E2 is one DNA element code, representing a certain fabrication machine employed by a certain fabrication process.

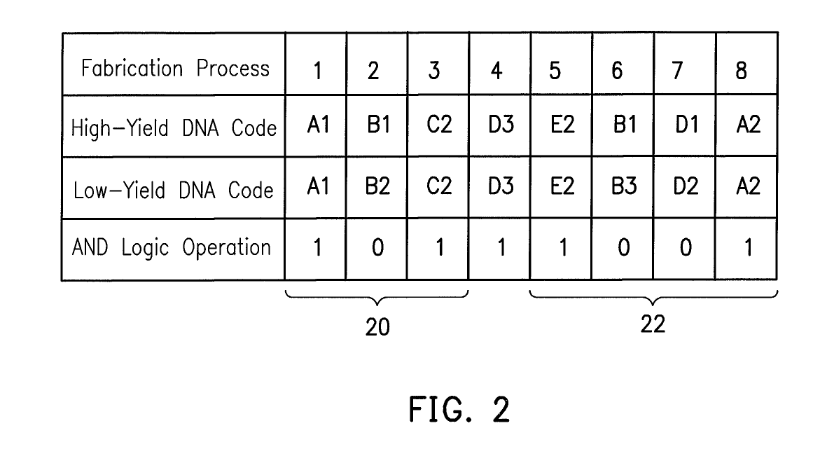

FIG. 2 is an AND logic operation algorithm of an analysis method for a consequent effect, according to a preferred embodiment of the invention. In FIG. 2, for example, there are eight fabrication process necessarily to be passed for one complete fabrication, and there are three available machines for each fabrication process. The second row shows one high-yield DNA code, which is one of fabrication machine clusters, having relatively higher yield rate. There are several high-yield DNA codes stored in a data base. The one, that is, A1-B1-C2-D3-E2-B1-D1-A2 is one of the data base of the high-yield DNA codes. The third row, that is, a low-yield DNA code, A1-B2-C2-D3-E2-B3-D2-A2 represents a DNA code with relatively lower yield rate, and is to be analyzed by the method of the invention. The fabrication process may include, for example, a first stage 20 and a second stage 22. The second stage 22 may also repeatedly use a previous fabrication machine.

The logic operation algorithm is, for example, following. An AND operation, for example, is performed on each DNA element code between the high-yield DNA code and the low-yield DNA code. If the DNA element codes of the high-yield DNA code and the low-yield DNA code in the same process are the same, an AND logic operation result is indicated by “1”, and otherwise is indicated by “0”. In the DNA codes shown in FIG. 2, the second, sixth, and the seventh fabrication process have “0” logic results because the pairs (B1, B2), (B1, B3), and (D1, D2) include different machines in their individual process. All of the fabrication machines, B2, B3, and D2 may cause a poor yield rate. Manufacturers can replace the fabrication machines, B2, B3, and D2 with the other two available fabrication machines. For example, B2 in the low-yield DNA code at the second process can be replaced by either B1 or B3; B3 in the low-yield DNA code at the sixth process can be replaced by either B1 or B2; and D2 in the low-yield DNA code at the seventh process can be replaced by either D1 or D3.

After modifications of the low-yield DNA code, the yield rate can be increased. Fabrication time and fabrication cost can be also reduced.

Since a sufficiently large number of high-yield DNA codes can be collected to form a data base, the analysis of the low-yield DNA codes can be more freely performed with more choices of the referencing high-yield DNA code. Several low-yield DNA codes can be analyzed in one time of analysis. The analysis can also be performed beforehand if the yield rate has a tendency to be decreasing. Therefore a consequent effect of a fabrication machine cluster can be judged beforehand. Since the analysis algorithm is globally applied and automatically performed, a large amount of data can be analyzed without an ignorance of any possible reason causing the poor yield rate. In the above descriptions, the DNA code can also represent any kind of a cycling series of processes or machines.

In conclusion, the invention has following characteristics. The analysis method using a logic analysis algorithm to analyze the consequent effect of the fabrication machine cluster or a discrepancy between each of same-type fabrication machines. The analysis can be performed automatically with a large amount of data or the DNA codes so that there is no missing factor, which may potentially cause a fabrication failure, resulting in the poor yield rate.

The invention has been described using an exemplary preferred embodiment. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. An analysis method for analyzing a consequent effect of a fabrication machine cluster, the analysis method comprising:
providing a data base comprising a plurality of high-yield DNA codes and a low-yield DNA code, wherein each DNA code comprises a plurality of DNA element codes, each of the DNA element codes represents a machine employed by a process, and each the process comprises a plurality of available machines, that are, available DNA element codes;
comparing the low-yield DNA code with one of the high-yield DNA codes from the data base, wherein if any of the DNA element codes of the low-yield DNA code is different the DNA element code of the high-yield DNA code in the same process, the any of the DNA element code of the low-yield DNA code is indicated to form at least one indicated DNA element code; and
modifying the indicated DNA element code of the low-yield DNA code with one of the other available DNA element codes used in the same process.

2. The analysis method of claim 1, wherein the machine comprises a semiconductor fabrication machine used in a semiconductor fabrication process.

3. The analysis method of claim 1, wherein the step of modifying the indicated DNA element code comprises replacing the indicated DNA element code of the low-yield DNA code with one of the DNA element code of the high-yield DNA code belonging to the same process.

4. The analysis method of claim 1, wherein the step of comparing the low-yield DNA code with one of the high-yield DNA codes comprises a logic algorithm.

5. The analysis method of claim 1, wherein the step of comparing the low-yield DNA code with one of the high-yield DNA codes comprises an AND logic algorithm for comparison, in which the indicated DNA element code is indicated by “0”, and the DNA element codes of the low-yield DNA code other than the indicated DNA element code are indicated by “1”.

6. An analysis method for analyzing a consequent effect of a fabrication machine cluster, the analysis method comprising:
providing a high-yield DNA code and a low-yield DNA code, wherein each DNA code comprises a plurality of DNA element codes in a series order, each of the DNA element codes represents a machine employed by a process, and one the process comprises a plurality of available machines, that are, available DNA element codes;
operating a logic operation between the high-yield DNA code and the low-yield DNA code to indicate the DNA element codes of the low-yield DNA code, wherein each of the DNA element codes of the low-yield DNA code is different from an operated one of the DNA element codes of the high-yield DNA, then the each of the DNA element codes of the low-yield DNA code is indicated by “0”, and otherwise is indicated by “1”; and
modifying the each of the DNA element codes indicated by “0” in the low-yield DNA code.

7. The analysis method of claim 6, wherein the machine comprises a semiconductor fabrication machine used in a semiconductor fabrication process.

8. The analysis method of claim 6, wherein in the step of modifying the each of the DNA element codes indicated by “0”, the each of the DNA element codes indicated by “0” is replaced by other one of the available DNA codes.

9. The analysis method of claim 6, wherein in the step of operating a logic operation, the logic operation comprises an AND logic operation.

10. The analysis method of claim 6, wherein the DNA element code comprises an encoded data, which carries sufficient informs to identify the machine itself and the process, which employs the machine.
